(19) United States
(12) Patent Application Publication
(10) Pub. No.: US 2014/0281850 A1
(43) Pub. Date: Sep. 18, 2014

(54) SYSTEM AND METHOD OF CONTENT STREAM UTILIZATION

(71) Applicant: Citta LLC, Garden City, NY (US)

(72) Inventors: Sai Prakash, Niantic, CT (US); Edwin Gnichtel, Madison, NJ (US); Abu Moniruzzaman, Queens Village, NY (US)

(73) Assignee: Citta LLC, Garden City, NY (US)

(21) Appl. No.: 14/212,823

(22) Filed: Mar. 14, 2014

Related U.S. Application Data
(60) Provisional application No. 61/785,219, filed on Mar. 14, 2013.

(51) Int. Cl. G06F 17/21

(52) U.S. Cl. CPC G06F 17/211
USPC 715/202

(57) ABSTRACT

Methods, systems, and apparatus, including computer programs encoded on a computer storage medium, for creating a content stream associated with a unique user identification. In one aspect, a method includes creating a content item; creating a content model associated with the content item; assigning one or more attributes or tags the content item or content model; selecting a content view style for the content item; publishing the content item in the selected content view style.

### RELATED APPLICATION

The present application claims the benefit of U.S. Provisional Patent Application Ser. No. 61/785,219, filed Mar. 14, 2013, which is herein incorporated by reference in its entirety.

### BACKGROUND

This specification relates to the creation of content presentable in multiple media forms from a single content stream, thereby improving personal productivity.

Content creation such as authoring documents, presentations, e-mails, etc., involves the creation of related content, often similar or the same content, across many different applications, for example, word processing, e-mails, spreadsheets, presentation slides, and other user applications. Users often must create individual files in each application type containing the same or similar information and content. For example, a summary of a report must be extracted from a word processing document and pasted into presentation slides. As drafts of presentation slides are exchanged between users, commentary and additional related content are typically created in e-mails and editorial notes. Such a process involves the creation of multiple content files across multiple software applications having same content or related versions of the content. Yet it is difficult and cumbersome to organize and track the many different files and versions of content can be lost in the process. Organizational and personal productivity software packages attempt to manage the creation of content across multiple media applications but the process is inefficient and negatively impacts productivity.

A significant factor hampering productivity continues to be the multitude of files in computing. Managing files, folders, versions, copies and synchronization gets in the way of productive content creation. The boundary between content types (such as document, spreadsheet, database & presentation) currently enforced by most content creation suites is artificial and unnecessary. This boundary originated during the times when personal computers could only run one application at a time and when there were no real worldwide standards for creating content. These boundaries are perpetuated today to preserve revenue streams for big corporations and are unchallenged due to monopolies in the current market.

There is a need for users to create different types of content but not for separate applications to do so. As such, there is a need for content creation that is a function of the individual (or team) aligned with their goals, which would define the context of the content.

In current content creation paradigms, the context of the content does not determine the way content is finally outputted, for example, if the context is about a presentation for work, the content will need to flow like a formal business presentation with a slide format. However, there is a need to refine the process of going from content creation to content format and output without burdening the user with figuring out how to deal with files, folders, copies, attachments in emails, different version of software tools and the like.

Further complicating current methods of creating and managing content across multiple applications is the issue of Computer Identity. Identity in personal computing is often meaningless—log-on credentials in a home environment are unimportant or meaningless to many users, largely because that credential does not bring much to the table and does not integrate, in a meaningful way, with other identities that are inevitable for the average user—most notably, social network identities, email accounts & corporate VPN credentials.

The market leading productivity suites of today are complex pieces of software. However, the licensing and distribution of these suites is obsolete and does not favor the average retail consumer today. Most suites are monolithic software packages with many individually-licensed applications that are expensive to deploy and maintain. Users are usually tied to a specific operating system, and consequently, some constrained hardware choices and form-factors. Despite common underpinnings (often with an XML slant to the schema), the applications in these suites still produce unique formats that preserve the need for complex integration patterns (embedded editors for cross-linking content). The Web is also viewed by these suites as lateral to the paradigm as opposed to being the center of a fundamental shift in the way people create, publish, collaborate on, store, find and sell intellectual property, which is the key variable of the productivity equation.

Another important aspect of the Web that is not truly addressed by current suites is the notion of social collaboration and crowd sourcing. Social collaboration is a very powerful way for innovation in the future and the creation of influential projects and campaigns. There are many web sites and software applications that aim to bring this to the end user but they drive different standards, mechanisms and formats for the creation and publication of such content, usually for the purpose of driving traffic to the site via the unique availability of said content. This does not really benefit end-users or improve the process by which end-users create content. A new standard is required that can work for multiple scenarios and hosts while improving the user experience of creating content through social collaboration.

As such, the present need for proprietary document formats in productivity tools, typically email, documents, presentations, basic databases and basic spreadsheets limits productivity and collaboration. The file-dependence and architecture of present applications that produce content is obsolete as most computing paradigms are focused around the creation of files/folders and synchronizing them across devices etc. This results in discrete, individually licensed applications with complex licensing, high price-point features and complex integration patterns when working with productivity software, whether at home or at work. Content integration between applications is inadequate, for example, e-mail as a separate application, often integrates into many applications but never integrates the content composition & conversation process as part of a productivity paradigm, especially for the ad-hoc creation of content. The same applies to other forms of messaging (Voice, IM, Facebook).

Current content creation applications involve different types of documents with different applications to author them, forcing the user to deal with complex embedded editors (OLE, in-line editing) thereby preserving the present notion that the primary type of a document is limited to word document, spreadsheet, presentation, email or database. This results in complex software (multiple apps) to install, update, backup and maintain for even simple personal content workloads.

Currently available productivity suites, by their organization and use of multiple applications limit intuitive collaboration between users working on joint or individual content, across work, social and personal identities. But strong pervasive identity associated with content can differentiate work contexts (personal, pro-bono and professional projects) and establish intellectual property ownership.

### SUMMARY

This specification describes technologies relating to the creation of content streams associated with a unique user identity.

In general, one innovative aspect of the subject matter described in this specification can be embodied in methods that include the actions of creating a content item associated with a unique user identity, associating a content model with the content item, assigning one or more attributes or tags to the content item or content model; selecting a content view style and publishing the content item in the content view style. Other embodiments of this aspect include corresponding systems, apparatus, and computer programs, configured to perform the actions of the methods, encoded on computer storage devices.

In one example implementation a method performed by data processing apparatus, comprises the steps of: creating a content item; creating a content model associated with the content item; assigning one or more attributes or tags the content item or content model; selecting a content view style for the content item or content model; and publishing the content item in the selected content view style.

Example implementations of the present invention may include one or more of the following features: The content item is associated with a unique user identity. The content item comprises alphanumeric text (typically, but not limited to, HTML code), audio data, graphical data, or video data. The content model further associates the content item with other content items related by context of the data comprising the content item(s). The one or more attributes or tags are automatically assigned to the content item or content model based on the context of the content item, user identity, time, geographic location; or other tags previously assigned to the content item. The one or more attributes or tags comprise a user assigned value; and automatically assigned value; or a collaboratively assigned value. The content view style comprises a textual document, a graphical document; a multi-media document; a report, a textual presentation, a slide presentation; a multi-media presentation; an audio presentation; an e-mail, a text message, an MMS message, a social media entry; an Internet instant chat message; a basic numerical computation model; or a PDF document. Publishing the content item in the selected viewing style comprises displaying the content item in the selected viewing style on computer monitor, on a remote monitor, on a remote display, on a projected display, on a laptop computer display, on a mobile device, on a cellular telephone, on a tablet computer, or playing an audio file over a speaker, broadcasting the content item over a network, or printing the content item in the selected viewing style. The method further comprises the step of selecting multiple content view styles for a single content item. The method further comprises the steps of editing the content item or content model and assigning one or more attributes or tags to the edited content item or content model. Editing the content item or content model is performed by multiple user identities or at least one user identity at different times. The method further comprises the step of storing the content item, content model, and one or more attributes or tags in a content stream associated with a user identity.

In yet another example implementation of the present invention, a method performed by data processing apparatus comprises receiving a content item via a user input, wherein the content item is associated with a unique user identity; associating the content item with one or more content models; assigning one or more attributes or tags to the content item or content model; receiving a selected content view style and assigning the content view style to the content item; and publishing the content item in the content view style.

Further example implementations of the present invention may comprise one or more of the following features: The content item comprises alphanumeric text, audio data, graphical data, or video data. The content model further associates the content item with other content items related by context of the data comprising the content item. The one or more attributes or tags are automatically assigned to the content item or content model based on the context of the content item, user identity, time, geographic location; or other tags previously assigned to the content item. The one or more attributes or tags comprise a user assigned value; and automatically assigned value; or a collaboratively assigned value. The content view style comprises a textual document, a graphical document; a multi-media document; a report, a textual presentation, a slide presentation; a multi-media presentation; an audio presentation; an e-mail, a text message, an MMS message, a social media entry; an Internet instant chat message; a basic numerical computation model; or a PDF document. Publishing the content item in the selected viewing style comprises displaying the content item in the selected viewing style on computer monitor, on a remote monitor, on a remote display, on a projected display, on a laptop computer display, on a mobile device, on a cellular telephone, on a tablet computer, or playing an audio file over a speaker, broadcasting the content item over a network, or printing the content item in the selected viewing style. The method further comprises the step of selecting multiple content view styles for a single content item. The method further comprises the steps of editing the content item or content model; and assigning one or more attributes or tags to the edited content item or content model. Editing the content item or content model is performed by multiple identities or at least one user identity at different times. The method further comprises the step of storing the content item, content model, and one or more attributes or tags in a content stream associated with a user identity.

In yet another example implementation of the present invention a computer storage medium is encoded with a computer program, the program comprising instructions that when executed by data processing apparatus cause the data processing apparatus to perform operations comprising: receiving a content item, wherein the content item is associated with a unique user identity; associating the content item with one or more content models; assigning one or more attributes or tags to the content item or content model; receiving a selected content view style and assigning the content view style to the content item; publishing the content item in the content view style. And the operations may further include: editing the content item or content model; and assigning one or more attributes or tags to the edited content item or content model. Editing the content item or content model is performed by at least to user identities or at least one user identity at different times. The operations may further include: storing the content item, content model, and one or more attributes or tags in a content stream associated with a user identity.

In still a further example implementation of the present invention a system comprises a user device; and one or more computers operable to interact with the device and to: receive a content item, wherein the content item is associated with a unique user identity; associate the content item with one or more content models; assign one or more attributes or tags to the content item or content model; receive a selected content view style and assign the content view style to the content item; and publishing the content item in the content view style. The system further comprises a server operable to interact with the device through a data communication network, and the device is operable to interact with the server as a client. The device comprises a personal computer running a web browser, or a mobile device running a browser. The system one or more computers consisting of one computer, the device is a user interface device, and the one computer comprises the user interface device.

In yet another implementation a system comprises two or more stream enabled user terminals connected over a stream cloud, wherein a first stream enabled terminal broadcasts a content stream for viewing by a second stream enabled terminal. The stream enabled terminal is a member of the stream cloud network, wherein hosting of content for a stream identity is done locally and sharing of content is directly between stream enabled terminals.

Particular embodiments of the subject matter described in this specification can be implemented so as to realize one or more of the following advantages. A consistent, long-term method of storing content generated by an individual(s) that transcends machine boundaries & software licenses. Stream technology allows end-users a way of centralizing and utilizing vast amounts of personal content that are currently locked inside of proprietary files and formats and which cannot easily be identified, searched and navigated; stream technology is a more natural way of dealing with intellectual property as it aligns the granularity of the storage and operations on content at the level of individual topics/concepts/thoughts. Stream technology allows IP to be navigated, stored and retrieved in a more intuitive way as it uses association/relationships among granular objects (content items, pictures) and associated context to create and identify content. Stream technology accounts for Time and Space (temporal geo-coordinates) in content storage which allows a natural user experience to be built that allows users to search and browse content on the basis of time and factoring in either physical location where the user is (at that time) or physical location where content was created or both. Stream technology allows for quicker, easier and more powerful publishing of content by aligning the use of models in content creation as a key part of the content creation workflow. Models allow Streams to leverage best practices, industry standards and technical methodologies in a way that is simple for the end-user but allows for very large and complex documents to be created over time. Stream technology protects the IP of individuals, companies and governments. The Stream implements granular security and access controls at the Content item level allowing for protection (integrity, rights-to-use) of documents at a lower level of granularity than currently available without combining complex tools. The Stream Cloud acts as an arbitrator of content ownership for all content items that are published to the cloud. Stream technology enables commercial interaction, within a single document, of multiple entities (individuals, companies, government entities) while preserving ownership, tracking contribution and ensuring that a fair compensation model can be implemented against the deliverables/documents produced in such manner. Stream technology defines a limited number of real-world objects (Content Items, Streams, Users, Companies, Government Entities) and then wraps metadata and associative relationships around those objects that allow users to style, present, re-visualize and share content. This allows for a more powerful way of using IP while simultaneously promoting the fidelity & re-use of the individual pieces of content (conceptual elements) that constitute that IP. The Stream, with its Content Model approach, provides an open and dynamic platform for the creation of applications that manipulate content. In effect, the Stream is a new base standard for the storage of arbitrary content that can be utilized by application developers to create a community of applications that can interact in new ways as content can truly flow freely between them. Stream technology allows for separation of the applications that create and sequence content using context from the applications that can manipulate content for visual formatting, styles and subsequently, applications that modify content for printing. This allows for innovation and improvement in each type of application without presenting a user experience for end-users that interferes with clean content creation. It also allows best-of-breed applications and tools to be intermingled by the end-user in the content creation process. E.g. a market-leading graphics tool or technical modeling utility could be used in conjunction with Streams to enable the end-user to do more with the content. And the use of credential contexts and profiles (buckets for sets of content) in Streams allows end-users to fundamentally separate content that is personal from content that is work-related or even social. This makes it easier for users to manage their content on their personal computers while allowing security and segregation to be applied to protect sensitive and confidential items. Stream technology provides Internet content authors/publishers (such as celebrity blog writers) to protect their content and prove copyright ownership of their content in court. And stream technology aligns the personal computing model for content creation and storage with the standards of the Web. This allows a user to naturally participate in Web publishing and easily create a powerful Internet presence that promotes that user, and allows the user to create a private and public content community on the Web.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example implementation of the present invention;

FIG. 2 is a block diagram of an example implementation of the present invention;

FIG. 3 is a schematic illustrating an example of electronic document creation from a content stream consistent with the present invention;

FIG. 4 illustrates an example system for performing the methods of the present invention.

FIG. 5 illustrates an example implementation of the present invention.

FIGS. 6A-E illustrate example implementations of the present invention.

FIG. 7 illustrates an example implementation of the present invention.

FIG. 8 illustrates an example implementation of the present invention from the user perspective.

Like reference numbers and designations in the various drawings indicate like elements.

### DETAILED DESCRIPTION

The Stream:

The content stream, in an example embodiment of the present invention, is a contiguous tag-based content flow using structured, temporal metadata to manage unstructured free-form HTML content snippets organized as a dynamic object graph. Content here refers to text encoded in HTML with embedded audio, video and graphics.

The content stream, aims to redefine the concept of a document as a snapshot in time of an ordered subset of the objects in the stream. In this context, a document, defined as above, can simultaneously be used for multiple information purposes—reading, presenting & printing being some examples. A core concept of Stream objects is the idea that any metadata required to render an object differently (say printing versus presenting) is created on the object as additional metadata layers and do not affect the core content behind that object.

Cardinality of Streams:

The definition of the stream enables a global perspective of content ownership, creation and collaboration. This perspective is based on the primary rule that a Stream represent a legally well-defined real-world entity rather than a technology-based artifact. This perspective also ensures that content storage and ownership is independent of any specific applications or platforms and is instead, only strongly tied to identity. To this end, a stream in the present invention always has a primary one-to-one ownership relationship with a person, organization or government (country) entity. This also allows the Stream platform to mediate collaboration and publishing of content at a global scale while respecting IP ownership, country-specific laws and dealing with the long-term arbitration of content ownership for legal purposes.

There is only one stream per user. Similarly, a company or a government entity also has exactly one stream each. Users don't create streams or organize them—streams are organized using contextual segmentation of content items. Consequently, there are no physical file and folder constructs within a stream. Contextual segmentation uses a user's identity, an activity label and timestamps to store and render groups of related content items. The segmentation is not meant to create a unique partition of the user's content akin to files and folders, where copies can exist but there is physical separation between them. Streams are designed to handle ALL user content at once.

Stream Object Model:

Content within a stream is stored effectively as an attribute and tag-based, schema-driven object graph, where the object primitives are one of five major types consisting of Content Items, Content Models, Document Views, Style Layers and Binary Objects.

Stream Object Namespace:

A Streams Directory & Object Namespace (also known as the “Streams Metaverse”), is a distributed, hierarchical and contiguous namespace of important objects and their attributes, including the object wrapper that can represent Content Items, Content Models, Document Views, Style Layers and Binary Objects. Stream objects such as Content Items, Content Models, Document Views, Style Layers and Binary objects constitute what is called Stream Data. The Streams Directory contains objects that represent identity and ownership of Streams containing Stream Data i.e. the real-world owners of said data. In addition, the Stream directory includes objects that control storage, configuration, services, applications and security. The Streams Metaverse is intermingled structurally with Streams Data and is used to locate Streams objects distributed across multiple potential data repositories, user streams, computer systems and networks. Objects are represented in the Streams Metaverse and are linked to each other, via attributes, by one object either owning or containing another object or holding a reference to another object thus forming an object graph.

Content Items:

Content Items are instantiated objects within the system that encapsulate tagged HTML-based text content that form a base class for all other types of content objects. The Content Item base class works in concert with binary stream objects to allow creating, editing and rendering content that goes beyond pure HTML content by using browser-compatible editing and rendering tools for different types of binaries e.g. images, movies, audio being some examples. Other examples of content items include variations of HTML-based content such as data grids with support for numerical formulae, rich HTML tables & graphical visualizations of data (potentially sourced from another content item). Content Models may represent a semantic model of content items that creates information through association, sequence, internal structure and data context.

Document Views represent collections of content items that are related and sequenced by the user. The sequence and selection of content items within a Document View are attributes of the underlying Content Model that has either been created for or applied to that particular Document View. Document views comprise two major types—dynamic and static (also known as rendered document views). Dynamic Document Views feature a collection of content items in an underlying Content Model that is always rendered in the most current state of each item. Any changes made to these item will show up when a Dynamic Document View is redrawn or refreshed. A Static Document view correspondingly, does not change and is a faithful snapshot in time of the state of all the associated content items in the underlying Content Model. Static document views comprise two additional sub-types: exported static views and native static views. Style Layers for content items, comprise three major types —text formatting styles, text layout styles and document view layout styles and can be simultaneously applied to document views that allow the user to, in effect, switch between visual formatting and representations. Binary Objects store media and graphics content such as audio, video and image content. These are objects that wrap the binary bytes of media and graphics files and add textual metadata to the header of the wrapped object to allow it to be logically embedded into a Stream.

FIG. 1 illustrates an implementation of a method of content creation utilizing the Stream concept of the present invention, taken from the user's perspective. For example, a user interacts with the Content Stream Engine (CSE) to generate content, to organize groups of content, to publish documents based on these groupings, and to share these documents with other users. Each user creates content within a single personal “stream.” Each addition to the stream is accompanied by relevant contextual descriptors in the form of tags. These tags are subsequently used to filter and organize relevant content, and to assist in populating documents with content ahead of publication.

Referring to FIG. 1, the user begins by creating a content item within his stream (100). Content items predominantly include text and media content. The user may also apply basic formatting to the content items, such as bulleted lists, number lists, and inline position attributes. Each content item is stored within the user's stream.

As each content item is created or edited, one or more attributes or tags are assigned to the content item (105). For example, as the user manipulates a content item, the content item is automatically tagged by the CSE with particular identifying information, such as the time, the geographic location of the user, and the identity of the user. The user may also manually specify additional tags, such as an activity tag to categorize the content item. These tags are retained alongside the content item within the stream, and help to uniquely define the content item based on its content, its creator defined by the user identity, and the context of its creation.

Binary Content References:

Streams handles the storage and use of media and graphics within the textual content in much the same way that a web application optimizes the use of such resources across web-based page content. In this context, Streams can import existing files from the user's file system or cloud share and organizes them using automatically created HTML representations (using text and icons)—manifesting as objects in the user's stream. These objects are linked to the binary object in the Stream that represents the actual content of the file whether it be an image, movie, audio file or document of some other application such as PDF. This helps represent the content in the stream and avoids the file-folder metaphor. The auto-created HTML content & tags for each binary object thus imported uses Stream's self-organizing algorithms to determine the best way to cross-reference the media files & graphics against the user's contexts and activities and create a visual index to enable the user to browse the content (e.g. browse via tag cloud or a keyword search).

Content Models:

Every Document View created in the Stream has an underlying Content Model. The Content Model is the set of attributes that defines, in its most basic form, what content items are to be included in a particular document view and in what order. The user may also define or select content models (110) to be applied to a document view being created. A content model represents a semantic model of content items that creates relationships between content items based on association, sequence, internal structure, and data context. A content model includes a set of content elements called model entities, a set of relationships between entities, a set of states and transitions for each entity (for example publication status, completion status, defunct data status), and a set of actions that can be triggered to change the state of the entity. For instance, if a user is interested in generating a price quote for a customer, the customer's name, proposed pricing, and proposed tasks could be entered as content items, then specified as model entities. The user then groups these model entities within a provided price quote content model, and specifies the model's readiness for inclusion into a publication. Content models, their constituent model elements, and the relationship between these elements may be defined independently of content items, or may be specified as a portion of or as the entirety of a content item. Content models are likewise tagged with contextual tags when used in a specific activity or document but are also made available to the user as a library of objects with powerful templating and content re-use capabilities.

At the core of a content model is the ability for the model to group related content within a document (cross-references and information themes) in a way that makes it easy for a reader to navigate and discover that content within that document. A very basic manifestation of this function is the use of the content model behind a document to store and render a nested hierarchy of individual pieces of content (say, by topic) with there being no limits to how many levels of nesting are used. A content model can also be used to tie together more than one document to create an information package such as a sales proposal to a customer that includes a proposal document, an executive summary document (for presentation) and a spreadsheet-style document for budget figures.

As content models, as defined previously, can contain actions and events, it is possible to create content models that behave like content applications or even, content services. The stream platform provides the execution context in which a model can be run as a long-running service or an application. An example might be a survey service that is created via a content model for surveys and executed to host a particular instance of a survey that is then filled out by various users over time.

A content model is also used to represent alternative narrative paths when rendering a document for reading, presentation or printing. In this context, a model can represent several different but related versions of a document where the choice of what version is displayed to a user is made by the reader or viewer as opposed to the author or presenter of the content, forming a radical shift in the way a document narrative is controlled. These different versions can also control the inclusion and even selective highlighting of content items in the document based on configuration settings and content targeting rules in the model.

Filtering and Context Activation

The Stream uses filtering via object attributes and tags, as the core mechanism for defining what content is being worked on at a given time. The main filters that establish context are identity, activity, topic and time. When a context is initially selected by the user, it is activated and becomes the center of focus, resulting in an immediate filtering of the Stream to reflect just the content items that are in focus for that context. For example, a user might contribute content into the Stream in a set of activities that are “current”. These represent what the user and related collaborators are “thinking” about or currently working on at present. Streams allows any piece of content (text, voice, picture, video) to be inserted into the stream against an activity, quickly and easily. This ensures that ad-hoc ideas and notes about a specific activity are immediately stored in a way that can be retrieved easily. This mechanism is augmented by an additional piece of context, namely the specific topic in an activity or document which any new content can be targeted.

Documents:

After the user creates several content items and/or nested content model elements, the user may aggregate one or more of these entities together to form a document. The user begins by filtering existing content items by specifying particular tags (115). For instance, the user may wish to specify that only content items and content models created by a particular user during a particular item period be shown. The user interacts with the CSE to specify the tags, whereby items fitting the criteria are selectively displayed from the user's stream. The user may further refine the filter, for instance by specifying that only content items or models of a particular activity tag be shown. The user may continue refining the filter until a desired subset of content items and model elements remain visible.

After filtering these items, the user then arranges the content items in the desired sequence (120). Though the user may continue editing and rearranging content items during throughout the document creation process, each content item and content model retains a history of its tags and may be edited or filtered based on the user's specified criteria.

The user then selects and applies a content view style and/or a style layer (125). Applying a document view converts the selected content items and content models into a specific document flow consistent with that of a traditional document. For example, the user may select a business letter document view for a pricing quote, and the CSE creates a traditional linearly organized letter that integrates the user selected content items and content models. Applying a style layer alters the appearance of the document. For example, the user may select a high contrast style layer, and the CSE alters the document to have high contrast colors, fonts, and layouts.

Document Publishing & Sharing:

When the user is satisfied with the content items and content models as they appear in the content view style, the user publishes the document (130). This document retains information regarding the content items, content models, document view, and style view, but may be viewed either as a stream-based document or as a traditional linear document.

This document may then be shared with other users (135). As other users revise existing content, at the content item level, and add additional content, one or more attributes or tags are likewise assigned to the appropriate content items and content models. In this manner, all contributions are tracked, and may be filtered along side the original content.

Multiple documents may be quickly generated from a single subset of content items and content models by creating multiple document views or by applying different style layers and visual models to the same document view. For example, a user may wish to create two documents from a single selected set of content items and content models, for example a price quote letter and a corresponding sales presentation. After the user selects the appropriate content items and content models (115) and arranges these items into the desired sequence (120), the user selects an additional document view and style layer alongside the first (140). Thus, using the same content used to generate, for instance, a business letter, a presentation is also created, lessening the need to reformat the same information into two different outputs. This document may also be shared alongside the first.

Changes to content items or models may be propagated across all associated documents. For instance, if the user revises a content item specifying a particular price quote, this change is carried over to the associated content model. Likewise, this change to the content model is carried over to the documents created by any number of document views and style layers. Hence, multiple documents may be quickly revised to incorporate new information without requiring that each document be manually edited.

Content Stream Engine Workflow:

FIG. 2 illustrates an implementation of a method of content creation utilizing the Stream concept of the present invention, taken from the perspective of the Content Stream Engine.

Referring to FIG. 2, the CSE provides a user with a stream and accepts entry of user defined content items (200). Content items predominantly include text and media content. The CSE also accepts basic formatting to the content items, such as bulleted lists, number lists, and inline position attributes. The CSE stores each content item within the user's stream.

As each content item is created or edited, the CSE assigns one or more attributes or tags to the content item (205). For example, as the user manipulates a content item, the CSE tags the content item with particular identifying information, such as the time, the geographic location of the user, and the identity of the user. The CSE also accepts tags manually specified by the user (210), such as an activity tag to categorize the content item. The CSE retains these tags alongside the content item within the stream, and the tags are used to uniquely define the content item based on its content, its creator, and the context of its creation.

The CSE also accepts entry of user defined content models (215). A content model represents a semantic model of content items that creates relationships between content items based on association, sequence, internal structure, and data context. A content model includes a set of content elements called model entities, a set of relationships between entities, a set of states and transitions for each entity (for example publication status, completion status, defunct data status), and a set of actions that can be triggered to change the state of the entity. For instance, if a user is interested in generating a price quote for a customer, the CSE may define the customer's name, proposed pricing, and proposed tasks as content items, and then define these content items as model entities within a price quote content model. Content models, their constituent model elements, and the relationship between these elements may be defined independently of content items, or may be specified as a portion of or as the entirety of a content item. The CSE likewise tags content models with contextual tags.

After the creation of several content items and/or model elements, the CSE aggregates one or more of these entities together to form a document view. The CSE first filters and orders content items and model elements based on a set of default filters (220). These filters may include, for example, items created by the current user concerning the current activity. The items may be ordered chronologically by default.

The CSE also accepts user input to further refine the filtering criteria and to alter the order in which the items are displayed (225). For instance, the CSE may selectively display only content items or models of a particular activity tag based on a filter set specified by the user. As the user continues to refine the filter, the CSE correspondingly updates the display until the desired subset of content items and model elements is shown. As items are filtered, the CSE also accepts user input regarding the sequence of the content items. As the CSE reorders the content items and content models, it retains a history of each tag, and allows each item to be further edited or filtered based on the user's specified criteria.

The CSE then creates a document based upon a user selected document view and style layer (125). Upon user selection of a particular document view, the CSE converts the selected content items and content models into a specific document flow consistent with that of a traditional document. For instance, the CSE may convert several content items and content models into a business letter document view, creating a traditional linearly organized letter that integrates the user selected content items and content models. The CSE also applies a style layer to render the document with a particular set of appearance parameters. For instance, rendering a document with a high-contrast style layer results in a document with high contrast colors, fonts, and layouts. The rendered document retains information regarding the content items, content models, document view, and style view, but may be viewed either as a stream-based document or as a traditional linear document.

This document may then be shared with other users (240). As other users revise existing content and add additional content, the CSE corresponding assigns one or more attributes or tags to the revised content items and content models. In this manner, all contributions are tracked, and may be filtered alongside the original content.

The CSE may generate multiple documents quickly from a single subset of content items and models. For instance, a price quote letter and a corresponding sales presentation can be created from a single selected set of content items and models. After the CSE filters and orders content items based (220 and 225), the CSE may also create an additional document using an additional document view and style layer alongside the first (245). Thus, using the same content used to generate, for instance, a business letter, a presentation is also created, lessening the need to reformat the same information into two different outputs. This document may also be shared alongside the first.

Changes to content items or models may be propagated across all associated documents. For instance, if the user revises a content item specifying a particular price quote, the CSE carries this change over to the associated content model. Likewise, this change to the content model is carried over to the documents created by any number of document views and style layers. Hence, multiple documents may be quickly revised to incorporate new information without requiring that each document be manually edited.

### Additional Embodiments

### Content Items

All content in streams is created in snippets called Content Items. Every content item is uniquely identified globally and is anchored by a topic header. Content items can retain their core text & graphics, with minimal formatting, even when being utilized in different contexts and document views. This is a key feature of the stream workflow—content creation, content styling and content publishing are separate activities that are layered on top of content items. Content items are ‘associated’ with contexts (identities, activities) as well as views that are formatted for easy reading & sharing. To ensure that the user is not distracted by formatting, sequencing and partitioning (chapters, sections), content items have very basic formatting for the text and media (inline positioning, basic bulleted & numbered lists, etc). Content items are visually arranged top-down by default with the ability for the user to select the visual style that works best—left-to-right, right-to-left, bottom-to-top etc. Content items have a Focus view that consists of just the list of topics, each displayed with a brief note stating the core message of the content in that item, and arranged like index cards in the visual orientation the user finds easiest to read. The focus view can also form the basis of the Table of contents for any document view being created from the relevant content items. The focus view acts as a checklist that can be displayed in a traveling side-bar—a visual style that ensures the content is easily visible while allowing the user to edit content items as usual. The focus view helps the user remember what the scope of the work remaining is, the ‘location’ of the current content being worked on against the full list of items that need to be produced and any additional notes that the user wanted to be reminded of per content item while working on the activity in scope.

Content items, and other Stream object types, are implemented using a tag markup system. All content items, associations with views, styling instructions and metadata are stored in Streams using either attributes on the wrapper object for the Content Item or tags that surround the content involved. The content itself is stored using a W3C-compliant HTML5 standard. Users can work at the Content Item level across collaborators, communication, document views, versioning and search. As there are no file boundaries or proprietary document formats (content is based on HTML), sending content to a collaborator is easy and can work for any recipient with access to a web browser.

As all content is logically in a single, contiguous store, users can also perform global search and global editing operations on their content. A user could find out that they've misspelled the word “fallacy” for the last 8 years or so and fix it in every piece of content they ever produced, if they so desired.

The globally unique identifiers on content items also allow content items to be exchanged outside the Streams system using communication channels, most notably email, and collaboratively refined. Content items have metadata associated with them to track editing time-stamps, versions & editing actions (such as applying or reversing rewrites on content items).

### Content Models

Every document has an underlying semantic model that defines structure and purpose and allows the document to perform a productivity function. Examples might be a business proposal, a software architecture document, a term paper or even a novel. There is always a format and a minimal set of information elements that are required for the document to achieve the goal of its author(s), whether they are individuals, companies or other legal entities. The main difference in these models is the level of dependence on technical standards and methodologies in the subject domains of the document as opposed to individual choices made by the author(s) about the structure of the content. Streams handles multiple aspects of this nature of content by providing the following behaviors:

1. Every document has a model. Not every model needs to be a document to offer value. Models are inherent in many things people do on a daily basis, without any immediate intent to publish outside of their own computing devices. For this reason, a model takes precedence over a document view in the Stream object model. A model can be applied to a document view to structure the document but a user typically adds content into streams with just models and content items. The model is what converts the raw data/content into information.

2. A free-form document typically has a model that is best represented by the table of contents of the document. Streams allows a user to structure a document view using a content model that could be entirely built by the user on the fly adding individual items to a content guide that helps track, author and sequence content items. These models can be saved as user-driven templates. However, technical standards and methodologies will be available in Streams to help correctly build content structure so that the document can achieve its purpose effectively.

3. An important aspect of the model is the creation of relationships between content items in the model wherein the relationships themselves are information. This is typically seen in more technical content models such as a software design model showing various parts of an application and their inter-relationship to create user value or medical information about a drug and the primary and secondary compounds that constitute the core of that particular drug.

Content models allow the typical Streams user to do the following:

1. Contribute random bits of content into streams (in any order, at any time, about anything) and immediately position that content against an activity (context) AND a model element. E.g. If a user had an idea about how to creatively price a service for a customer, that particular idea would not only go into the Customer Proposal activity the user created (which will show up in recent activities) but since the Customer proposal activity has an underlying model that states that it is a business proposal and has a model element for Pricing, the user can additionally target the Pricing element for this idea. This results in a proposal being built over time in a near automatic fashion since rendering the available content items in the content model for the proposal will generate a draft version of the proposal without additional effort. This method of work more closely aligns with how people think and function, multi-tasking over many activities at once, rather than forcing people to work the way document tools work.

2. Models allow the user to get help on creating a complete piece of information since the model provides cues on what items are more significant, what items are not completed yet (allowing for better task management) and what items can be rendered into a draft document view (marking completion state against individual model elements).

3. Models allow users to work collaboratively in a more meaningful and coordinated fashion. A team of users may choose to always have the same person(s) work on the pricing section of a proposal while another set of people may always work on the introduction and executive summaries of the proposal. A model could allow for content to be assembled from different streams while preserving the identity and ownership of the content against its author, allowing for remuneration and reward schemes to be implemented in different productivity scenarios.

Content models are structurally represented as a set of content elements called model entities (described by data elements and attributes akin to an XML schema), a set of relationships between entities (associations), a set of states and transitions for each entity type (publish status, completion, defunct data are examples) and a set of actions that can be triggered to change the state of the entity allowing for multi-user interaction with the model.

Selecting content to be presented or published together, sequencing that content (using topics to identify related text), choosing a flow layout for the content (a document flow or a presentation flow) and specific colors, fonts and other text styles are all activities that are layered on top of content items. This allows users to focus on developing the core message and then to spend time experimenting easily with the formatting and selection of available content in the creation of specific outputs, namely document views.

FIG. 3 illustrates an example embodiment of the present invention in with content items are published in a selected content view style.

FIG. 3 represents the content creation workflow within Streams across key artifacts. The figure represents activity from left-to-right (chronologically). The user begins by opening the Streams application and selecting or creating an activity. Opening an activity begin an editing session where the user can create content. During each editing session, the user can create a number of Content Items, represented in the diagram as orange squares. The user can also re-arrange these content items in the Stream view to flow according to the needs of the content being written (represented by the numbering of the orange squares). The user can then have a need to create a traditional ‘document’ that might be for reading/printing (called a document view) or for presentation (called a presentation view). To create either view, the user simply needs to select the relevant content items (in a drag-and-drop fashion). At this point, the views are created with content items that are linked to the original content items in the Stream. The link ensures that any editing changes to the core content within the item is allowed to propogate back to the original item (this link can be disabled per content item). The linked ‘copy’ of the content item is represented by the green squares. At this point, there may be additional information (headers/footers, slide titles, summary bullet points for a paragraph of content) that need to be created specifically to allow the document to perform its function. For example, a content item might be 10 paragraphs of text but the user may choose to summarize the item on a single presentation slide—the summary is called a View Markup element (represented in the diagram in purple boxes). In addition, the user can create and apply Style layers that represent style tags that need to be applied to content segments in either the linked content item or the markup item. Style layers are represented by red boxes. The engine composites these three items dynamically to render the resultant content —represented by the light-green boxes with the white borders.

### Identity, Context and Integration

Personal computer content is rarely tied to strong identity mechanisms. Modern platforms are starting to introduce new ways of associating Internet service accounts to personal computers (via the operating system) for the purposes of offering the inevitable cloud-sync service for files & folders. However, content is not dealt with at any sort of granular level in a way that reflects ownership, IP rules in effect (say, with the presence of a work contract with a company) and an awareness of the multiple internet identities required today for social computing and content sharing.

Streams ties the user's content to the set of identities the user owns. This is primarily done using a Stream identity that then maps contexts & content to identities, including personal, social and work accounts. Identity is the major component of Stream's contextual editing mechanism. Every piece of content created by the user has a default context—and thus a default identity—associated with it, that ties ownership back to the user. Identities can be issued to a Streams user in much the same way a Driver's license or Corporate badge are issued. This provides a way to both get access to content that is shared or collaborated by the group, company or government entity as well as author content in a way that respects ownership of that content with the user while adhering to privacy and IP laws established by the parent Streams entity involved.

Streams can also track the use of personal content (in a fashion similar to the use of DRM in distributing music) and contribute that content (at the content item level) into other contexts, while tracing ownership.

Streams also integrates with the prevalent Identity providers for personal and social content, allowing users to publish/collaborate content in the context of those identities. Examples might include Apple, Microsoft, Facebook, Twitter & LinkedIn. The integration with these identities accesses the directory and contacts associated with those identities in addition to the potential content that might be imported into Streams via those identities.

### Content Location Awareness

Stream content is geo-encoded, whenever possible. Contexts can have location affinity—a context can get activated by the presence of the user at a specific geo-location, or geo-location range. Streams attempts to use standard location services, if available, to help the user associate geo-locations against contexts. Streams also allows users to refine geo-associations by adding User, Company or Government Entity identifiers against the tags. Sensitivity tags in the Stream can be used to trigger visibility and rendering of content items when certain standard locations are involved—such as Public Places, Home or Work. Custom sensitivity profiles can also be created by the user for use in determining what filtering may need to be applied to the Stream in case the user is working in a specific environment—a great example of this is the use of this mechanism in ensuring that lawyers that collaborate on certain cases cannot display conflicting legal content across customer office locations they may visit, ensuring that no cross-sensitive information is visible.

### Storage and Time

There is only one stream per user, which ensures a unique association of the user stream to the universe of content streams globally. Users, Companies & Government Entities are the key levels at which streams get created.

The only permanent association that a content item has is with the stream in which it originated.

Content Items can be hidden using soft-delete (recycle bin metaphor) or hard delete (which removes it permanently). A permanent delete will not remove content items from the rendered Streams artifacts that may reference that content item but does remove it from document views that are marked ‘dynamic’ (which is the default). Streams uses tags to add identifiers, topic headers, activity, identity & ownership, time, event & action metadata around the core HTML content within content items. A tag system can allow text regions (words, sentences) to be defined and marked-up with metadata in an infinitely overlapping fashion without affecting the original text visually. This allows the user to manipulate unstructured text by adding structured content around it, allowing for more powerful ways of positioning, formatting and visually rendering that text. More importantly, the tag system allows the Streams engine to manipulate, multi-use and layer attributes (styling, display, sequence, priority/rating) on top of the original HTML content. Document views are assembled via association, not hierarchies/nesting of content items. Streams, identities, activities, content items, content item versions, messages, events, document views, temporal tags (actions, subscriptions) are all ‘associated’ through vector relationships with time that support bi-temporal resolution giving a truth-in-time perspective of the state of both a content item or a document view. The use of tags in the content storage is implemented as a compositing engine that does pre-processing of content items in different contexts to help the user interface render the version of the content that is expected. The compositing produces a resultant HTML content item and loads requisite metadata into the UI to support context-sensitive tools, schedule reminders, task notes, active related items (in-progress doc views) etc. Note that temporal tags are used to insert deadlines and targeted end dates from a task management perspective.

The work done by the compositing process is also used to create a temporal map of the content item that can be used for temporal browsing of the content (visual version history). Temporal tags are also inserted to trigger correlation processing of content items that may be waiting on an ‘event’. Temporal tags are also inserted to trigger correlation processing of content items that may be waiting on an ‘event’. The tags act as triggers to inspect correlation tokens and determine if an internal or external event has occurred that changes the state of that content item. For example, a content item may have been sent via email to a friend for a review of grammar and the event being waited on is an email reply to the original conversation with a modified version of the content or comments attached to it. This mechanism is the basis of the underlying content event system in Streams. Another facet of the event system is the creation of subscriptions. A subscription is a recurring trigger for internal or external events that either update or create content. Internal events are those that happen inside Streams, covering both individual user instances of Streams and the Cloud back-end of Streams. External events are those that Streams is capable of capturing via standard protocols such as HTTP, IMAP, ATOM, RSS etc. Examples might be: updated Wiki pages on a particular topic or new items in an RSS feed or a change to the first-page results of a Google search.

### Distributed Stream Content

The following set of mechanisms describes the capability to convert any personal or enterprise resource into a networked member of the stream cloud. Broadly, each member of the stream cloud retains local copies of the stream content of its local users, as well as cached copies of stream content from one or more remote members of the stream cloud. Each stream member may request, access, and cache stream content from other stream members of the stream cloud, either by locating stream content through metadata stored within each stream, or through one or more content directories. Stream members may be connected broadly through the Internet, connected through peer-to-peer networks, or connected through private Enterprise networks. Stream content may be distributed or otherwise regulated through these connections, such that stream content from each user is distributed only to its intended audience.

Referring to FIG. 4, an implementation of the content storage and distribution system includes several components: Content Items, Resource Items, the Streams Cloud, Streams Clients, Enterprise Appliances, and Streams Communication and Routing Engines (CREs).

Content Items are the most granular unit of content organized in Streams. A Resource Item is a binary or other non-textual item contained within a Content Item. For example, this may include pictures, videos, audio, or other such file.

The Streams Cloud includes Streams Data and Resource Stores & Caching. The Streams Cloud also includes Web Application hosts.

Each Streams Client is a rich-client application instance of Streams that provides access to the core cloud-storage of Content Items & Resources items, along with access to local cached instances of the users Streams data. Each Streams Client also provides routing and access to distributed instances of data located on other participating peer-to-peer Streams users. Streams Clients can include PCs, smart-phones, tablets, or other such devices.

Each Enterprise Appliance includes an instance of Streams Data, Resource Stores & Caching, and Streams Web Application hosting. An Enterprise Appliance is designed for customers who wish to participate in the Streams cloud (including the common Streams Metaverse), but who wish to keep their Streams data stored on-premises. An Enterprise Appliance allows connectivity to, and provisioning of, enterprise storage (SAN, NAS, etc.) for use with Streams.

A Streams Directory & Object Namespace (also known as the “Streams Metaverse”), is a distributed, hierarchical and contiguous namespace of all important objects and their attributes. For ease of discussion, the Streams Metaverse is described herein as a single entity. However, in actual implementation it is partitioned across multiple data stores and is intermingled structurally with Streams Data. The Directory & Object Namespace is used to locate items distributed across multiple potential Streams stores and across the Citta cloud, peer-to-peer networks, and customer environments with Enterprise Appliances. The Streams Metaverse is accessible, in different methods, via both the Hypermedia API (a Domain Tier component) and the Storage API (Infrastructure Tier component).

A Streams Communication & Routing Engine (CRE) provides coordination for Content Item & Resource Item lookup and retrieval across physical and logical boundaries within Streams. There is a centralized CRE instance located in the Citta Cloud, and distributed CRE instances implemented on every Stream Rich Client and Citta Streams Enterprise Appliance. Client & Appliance CRE instances work in conjunction with the Cloud CRE to orchestrate, configure and advertise routing and communication configurations to permit communication between each other.

For instance, a client CRE behind a Network Address Translation (NAT) router can use IGDP to configure the routers port-mappings to permit inbound communication from another CRE for peer-to-peer communication; subsequently the CRE will register this configuration with the Cloud CRE. In the event direct CRE to CRE communication is not possible, the Cloud CRE can act as a proxy for traffic between peers.

In some embodiments, the Cloud CRE can act as a content item proxy for standard web publishing. If a user publishes Streams data to the web (via standard web servers, blog services or social media sites) a user not wishing to pay for or consume Citta Streams cloud storage can use their own Client or Enterprise Appliance surfaced storage instead. The Cloud CRE will retrieve the data via connectivity to the local CRE instances

In some embodiments, proxied data may be temporarily cached in Streams Cloud Data and Resource caches.

In some instances, the CRE runs as a persistent service, and is implemented as part of the Application tier and sits below the Hypermedia API and above the Storage API.

The above components may be used to store and distribute content. In an example embodiment, a user wishes to access content from the Citta cloud storage. Referring the FIG. 5A, the user first attempts to access a Content Item, which results in a local client request to the users Local Cache & Resource Store. Referring to FIG. 5B, if the Content Item and any related Resource Items are not present in the local cache, the local client subsequently issues a lookup to the Citta Cloud CRE, which parses the Directory & Object Namespace (Metaverse) lookup. Referring to FIG. 5C, the Cloud CRE replies to the lookup request with the Content Item and, as part of the Content Items metadata, the Metaverse and cloud storage location. Referring to FIG. 5D, the Client stores a cached instance of the Content Item (and related Resource Items) in the local cache. If the Content Item is part of an Activity flagged for persistent caching, the cache will be continuously synchronized and the client will use this data for local access rather than accessing the cloud instances.

In another example implementation, a user wishes to access content stored on a peer-to-peer network. Referring to FIG. 6A, the user attempts to accesses shared Stream content, in this instance a large Resource Item that is not stored in the local Stream Client local cache or in the Citta Cloud. Referring to FIG. 6B, the local CRE then queries the Cloud CRE to retrieve the location of the Resource Item object. Referring to FIG. 6C, the Cloud CRE replies with the Metaverse location metadata of the Resource Item and the location CRE's communication parameters. Referring to FIG. 6D, the Client local CRE contacts the remote client CRE and, referring to FIG. 6E, retrieves the Resource Item object. As before, if the Content Item is part of an Activity flagged for persistent caching, the cache will be continuously synchronized and the client will use this data for local access rather than accessing the cloud instances.

In another example implementation, a user wishes to retrieve a Content Item from a local Enterprise Appliance. Referring to FIG. 7A, the user attempts to attempts access a Content Item for the first time, and the client determines that the item is not present in the local Client cache. Referring to FIG. 7B, the local Client CRE requests the Cloud CRE lookup the Content Item in the Streams Metaverse. Referring to FIG. 7C, the Cloud CRE responds with the Citta Enterprise Appliance object location and CRE configuration. Referring to FIG. 7D, the client retrieves and caches the item from the Enterprise Appliance.

In another example implementation, a first user wishes to retrieve a second user's web published content via a Cloud CRE proxy or redirect. The second user first publishes Streams content (including Content Items and associated Resource Items) to a blog or other web published location. The second user opts for free or entry level Streams account that does not include sufficient Resource Item storage (or user opts not to use storage for Resource Items), and configures Local Streams Rich-Client to use local PC storage or peer-to-peer sharing. The first user may access the published content by accessing a link to the Resource Items (videos, images, etc.), which resolves to the Cloud CRE. The Cloud CRE receives the request and passes the request to second user's Client Local CRE. If the Client Local CRE is able to service the request on the common HTTP/HTTPS port, the Cloud CRE responds with an HTTP Redirect to the IP address of Client Local CRE and the associated Resource Item URL/URI. If the Client Local CRE is not directly accessible via HTTP/HTTPS, the Cloud CRE proxies the Resource Item retrieval and caches the object for a temporary duration of time.

### Content Workflow Case Study using Streams

This section describes a detailed case study for how content is authored using the mechanisms & features of Streams.

### Background

The case study involves the creation of a work proposal for a potential customer, a company called XYZ, detailing the delivery of a technology solution capable of enabling the XYZ company website to be revamped. The new site is to allow visitors to the website to register for a personal account, order products online and have them fulfilled by XYZ. The current website is several years old and does not feature any such capability. The people involved in this scenario are identified in Table 1 below.

TABLE 1

| User | Role | Comments |
|---|---|---|
| Stream_MainUser | Main lead on the authoring of | This case study begins as |
| | the proposal. | content in the stream |
| | | belonging to this user. |
| Stream_TechUser | Technical lead on scoping out | The technical lead will |
| | and providing a solution to the | contribute entire sections of |
| | technical requirements of the | the work proposal from |
| | customer. | his/her Stream in this case |
| | | study. |
| Stream_FinancialUser | Person that helps the | This user has developed |
| | Stream_MainUser figure out | Financial content in Streams |
| | how to estimate the price of this | that can be used to build the |
| | solution for the customer. | pricing section of the work |
| | | proposal being written. |
| Customer Lead | The main contact at the XYZ | This could be a user that |
| | company that is responsible for | could lead a whole team of |
| | vetting and signing the work | people at the customer |
| | proposal for the new web site. | company, XYZ. In this |
| | | scenario, this user could |
| | | represent an individual that is |
| | | a sole proprietor and wants to |
| | | build a new website. |

This scenario illustrates core stages of a content production process that are not specific to any vertical scenario—such as the website proposal used here which is specific to the Software Development industry—but can be leveraged across all types of content creation activities. Similarly, the organizational boundaries in this use case, which features a customer organization and a team of people that could be working for the same company and proposing a solution to the customer's website needs, can be substituted with sole proprietorships, individual consultants, pro bono teams from social networks and individual customers alike.

### Initiating the Activity for a New Work Proposal

The scenario begins with a conversation at the office in Manhattan, NYC of XYZ corporation between the Customer Lead and the Stream_MainUser. At the start of the conversation, Stream_MainUser opens the Stream client (built with the Content Stream Engine) and an activity gets created with geo-coordinates embedded into the activity header that reflect the location where that activity was started. The activity title is set to “Web Site Proposal for Customer XYZ” by the Stream_MainUser. At the start of the conversation, the activity is a simple activity that has a default “ad-hoc” content model—this implies that the activity has zero content items or suggested topics in the Focus Guide and is expected to be authored from scratch by Stream_MainUser. Stream_MainUser also starts typing notes from the conversation into a Content Item as the Customer Lead talks about the requirements for a new web site. After the initial conversation, Stream_MainUser spends time the next day to review the content item with the notes from the requirements. When Stream_MainUser opens the Stream client the next day, a list of current activities under the Work profile includes the newly created Web Site proposal activity created on-site the previous day. Clicking on the activity opens the Stream View editor and automatically scrolls the view to the last Content item and line being edited.

### Structure of the proposal

At this point, Stream_MainUser realizes that the activity will produce a Web Site Work proposal and proceeds to do a search of the available Content models in the Stream client. Stream_MainUser finds a content model that reflects a technical proposal of work for building a web site and selects that model to be applied to the XYZ activity. As soon as this is done, the Focus Guide gets populated with a number of content item placeholders identified by a set of suggested Topic headings and attached notes for each heading, reflecting what the content item is about. This is the core of a model definition in the Stream engine—namely, its content schema.

The newly selected model for the Web site proposal features the following list of content items in the Focus Guide:

1. Introduction

2. Customer Requirements for the Web Site

3. Proposed Solution to meet requirements

4. Technical Architecture of Proposed Solution (nested model)

5. Proposed Costs and Resources (nested model)

6. Licensing Terms of the Software Solution

Stream_MainUser also finds that the current model selected for the XYZ activity allows for flexible editing of the content schema (headings & sequence of top-level content items)—other models can be designed to insist on specific pre-defined headings and structure as part of industry technical standards or regulatory requirements for the type of activity in question.

### Collaborating with the Customer

The Stream client also allows Stream_MainUser to send an email to the Customer Lead with the proposal model (including sample text). The email includes a hyperlink that is configured to allow the Customer Lead to register on the Stream Cloud as a recipient of Stream content (assuming the Customer Lead is new to Streams). This allows the Customer Lead to login and view content such as the model of the proposal and comment collaboratively on the model. This also allows the Customer Lead to propose additional sections to the proposal that may not have been featured in the original model.

Whenever visiting the Stream cloud collaboration site, the Customer Lead is shown a home page that summarizes all activities that are currently active in collaboration with Stream_MainUser as well as an Activity landing page that shows currently active collaboration items such as the Proposal model. Stream_MainUser can share draft content items as well as allow the Customer Lead annotation and append rights on appropriate content items. The edits that the Customer Lead makes are received as events in the Stream Client of Stream_MainUser and various operations can then be chosen such as merge edits, append additional text and read annotations/feedback on existing content.

### Collaborating with Internal & Virtual Teams

The model selected for the Web Site proposal activity also suggests to Stream_MainUser that there are a number of different types of content areas of the proposal by offering a Setup Team option in the Focus Guide. The model features a suggested list of Roles of team members required to write the proposal. Note that this acts as a starter for the Team setup option—Stream_MainUser can configure as many or as few other collaborators as required for the proposal activity. Currently, there is only one person (Stream_MainUser) configured as the owner of the activity. Again, regulatory rules could be applicable in the model and require the participation of specific role or even specific people most notably, in corporate usage scenarios where a legal department or PR department may be mandated for certain activities.

Stream_MainUser decides to involve a web technology specialist, Stream_TechUser, as part of the team. Stream_TechUser is from a different organization that is often sub-contracted by Stream_MainUser for specific technology projects. Stream_TechUser is a Streams account holder and receives the invite from Stream_MainUser displayed by the Stream client and accepts the invite to become a part of the team. Stream_MainUser also adds a billing specialist, Stream_FinancialUser, to the team.

At this point, Stream_MainUser assigns ownership of different sections of the proposal to different users as follows:

| Content Item | Owner |
|---|---|
| Introduction | Stream_MainUser |
| Customer Requirements for the Web Site | Stream_MainUser |
| Proposed Solution to meet requirements | Stream_MainUser |
| Technical Architecture of Proposed Solution | Stream_TechUser |
| (nested model) | |
| Proposed Costs and Resources (nested model) | Stream_FinancialUser |
| Licensing Terms of the Software Solution | Stream_MainUser |

Note that content from Stream_TechUser is owned by a different organization (or Stream_TechUser as the case may be) and is integrated into the activity view of Stream_MainUser via a method called Compositing where the Stream engine can display linked and referenced content items in near real-time across users, companies and activities. When ownership of the Technical Architecture content item is assigned to Stream_TechUser, the content item transitions from a placeholder in the model (since at this point, it is empty except for sample content) to a linked content item from the stream belonging to Stream_TechUser. The content item gets created in Stream_TechUser's stream automatically using context and model information received from the original activity in Stream_MainUser's stream. However, this content item is created with a globally unique identifier that maps ownership to Stream_TechUser. Stream_TechUser then effectively licenses use of that content item under terms that exist between the two organizations or that may be setup in Streams for just that activity.

Using tag markup, the content item that Stream_TechUser works on includes model information received from Stream_MainUser that ensures that a consistent technical model is applied to the description of the technology to be used to build the new web site for XYZ. Another important feature is that Stream_TechUser has read-only access to other content items in the activity that the technical role assigned requires from the proposal activity. In this scenario, Stream_TechUser is able to view in real-time, read-only copies of the Introduction, Customer Requirements and Proposed Solution content items from the main activity.

### Gradually Building a Draft

Stream_MainUser finds that there are a few more people at XYZ that need to be met as part of ensuring that pertinent information relating to the web site requirements is gathered. On the second visit to the Manhattan office of XYZ, Stream_MainUser starts the Stream client application and is prompted to automatically switch to the Web Site proposal activity since it maps very closely in geo-coordinates to the creation location of the activity. In addition, there is an option to automatically open this activity when within a specified range of this office.

In each subsequent meeting with the customer, Stream_MainUser has the option to rapidly create content items or append to content items in different sections of the model. For example, while driving, an idea relating to billing might occur to Stream_MainUser. At this point, the mobile client of Streams could be activated with the quick-create option which would allow the user to dictate a note and would then allow the user to confirm where to append the note by transliteration of the current model elements—Introduction, Customer Requirements, Billing etc. One of the key aspects of context-driven startup in Streams is the ability for the user to context-switch rapidly (mid-conversation for example) and map new content (such as a voice note) against both an activity and a content item to ensure that information is captured in the right context for subsequent retrieval and review. This context-based creation of content can be applied to content from emails, chat conversations and online web conferences which allows the draft of the content to be created over time in an incremental, collaborative fashion.

The Stream client also uses an embedded identifier in emails wherein a content item is sent to a collaborator that intends to reply by email. Any replies with that identifier can then be processed automatically by the Streams client and the data in the response be added as inbound content against that content item.

The Focus Guide also plays a critical role in the creation of the draft proposal since it acts as an aggregator of progress, status and events for work being done in each content item of the model. The activity owner (Stream_MainUser) and the owner of the individual content item can both add tracking data to the header of the content item that is then used to display agreement on expected due dates, individual tasks involved in completing the content in that content item as well as percentage complete and other data that can be tracked against both the item and any associated tasks. This information often flows from multiple streams that synchronize the status of the content items across different Stream clients to ensure that a consistent set of data points is displayed. This allows Stream_MainUser to have a clear sense of progress being made against individual pieces of content and allows sharing of this status information in updates to the Customer Lead.

### Using Textual Content References

Stream_MainUser inspects the list of content items that need to be done and identifies that the Licensing Terms content item can be populated from a boilerplate reference that is available for these terms. Stream_MainUser will perform a quick search to identify the appropriate textual reference in much the same way an inline model search was performed at the start of the activity. The selected textual reference can be used in a number of ways:
1. If the text is ready to be used as-is, it can simply be inserted into the Content item. Text used in this manner is linked into the content item—a reference to the original content item is used to populate the text. This ensures that if there are updates or changes to the content, Stream_MainUser will be notified that these terms or policies have changed and affect the way the proposal is being created. Such notifications can also be applied to proposals previously created to perform an impact analysis on any active contracts with customers such as XYZ. Stream_MainUser can also do a quick spatial search and display a visual graph of all references used by the current activity in the Stream or all activities in the Stream that currently use the same textual reference.
2. Textual references can include a list of variables for text substitution that can be filled prior to inserting the item. An example of a specific reference could be the name of the company (XYZ in this case) involved to whom the terms are addressed.
3. A textual reference from a previously written content item from another activity within the user's stream can be used too. The Stream allows Stream_MainUser to perform a ‘sanitize’ operation on the text which ensures that any entities recognized as real-world organizations, people, countries, prices etc. can be listed and either removed or substituted by Stream_MainUser prior to inserting the content into the target content item. Content inserted in this fashion is a copy of the original content and not a linked reference.

During the week that the first draft of the proposal was being put together, Stream_MainUser received a visual alert that the boilerplate used for the Licensing Terms section of the draft proposal had been revised with newer and more stringent legal terms and it was recommended that the newer text be used in any proposals in progress. By selecting the ‘Update content reference’ option in the Licensing terms content item, the item is regenerated to the newer version. Version history and side-by-side comparison options in the Stream client and Stream cloud allow both internal team members and the Customer Lead to inspect the changes.

### Using Content Model References

Some of the content items are themselves nested content models with relationships and references encoded into their structure—in this case, the Technology Architecture section features a software architecture content model that describes the use cases, database design, software components and Web server deployment facets of the proposed new site. A nested content model is not hierarchical in the true sense of the term—nested content models feature content items at the same level as the parent. The difference is that the content items are grouped together by association with (a) the parent content model they are a part of and (b) relationships with each other defined by the user.

Each of these elements are inter-related as a single Use case can map to related elements of the software, database and physical deployment. The Technical Architecture model makes those relationships explicitly available—the user can choose what items are related to what in the model. In our example, Stream_TechUser can create a Use case content item for the display of a catalog of products that can be purchased online in the new website. This content item in the technology architecture model, can have optional relationships with content items that represent database elements, software components and physical servers that host these assets. In our example, Stream_TechUser may associate the ‘Display catalog of products’ use case with a data model content item showing Catalog tables within the web site database, as well as a set of software classes that are used to implement the functionality of catalog creation, maintenance, search, retrieval and display. This allows technical reviewers in XYZ that the Customer Lead may choose to share the proposal with, an ability to walk through the document and click through references between related elements that represent more complex information than simple hyperlinks since these references can have metadata associated with them (defined in the content model) and filled out by Stream_TechUser to help provide as much useful and context-sensitive information as possible to describe each technical component of the proposed solution.

### Using Computational Models for Pricing

Stream_FinancialUser can also use a nested model in the creation of the billing content item within the proposal. This model could involve tabular content that represents a computational model for prices and features a row-column interface for entering information to calculate costs based on the type of work involved. In this case, since the model involved is a Web Site development model, the model allows Stream_FinancialUser to select from 2 computational models that have previously been setup—one that involves a fixed-price approach to the work and the other that features a variable rate with a percentage of tolerance on the final amount. Stream_FinancialUser can select either model and insert it into the Billing content item.

### Sharing Automated Internal Drafts

As all content is typically inserted against specific content items within each activity, the notes, emails, chat and discussion minutes from the team members are all captured and stored against the appropriate portions of the content model. This allows the Stream Client to render a draft of all the information available automatically without any additional help in collating, copy-paste or other forms of information aggregation. Such drafts would typically be shared for internal consumption of the team prior to refining the content items to the extent that a draft can be submitted to the Customer Lead. The value for Stream_MainUser is that, at any time, an immediate draft of all current content on the proposal is available for review or sharing. This is on account of the contextual nature of storage of content in Streams and the ability to composite a resultant activity from distributed content items across Streams (users).

### Assembling Interim Presentations for the Customer

The Customer Lead indicates to Stream_MainUser that the senior management at XYZ would like a summary presentation of the current proposal to ensure that it was to their collective liking. Stream_MainUser then polls the Focus Guide to review the completion status of all the team members involved and determine which content items could be represented in the interim presentation for the XYZ management team. Stream_MainUser decides that the Introduction, Requirements and Solution content items are ready to be summarized in presentation and selects these three content items and clicks on the ‘Create Document View’ option. The document view dialog then asks how the document view is to be formatted—for reading or for presentation. Stream_MainUser selects presentation and is then directed into the Document View editor for Presentations. The editor creates 3 ‘slides’ by default with each linked content item from the Web Site proposal activity represented in a slide. Stream_MainUser can now decompose the text of each content item across a number of slides. The Introduction content item is lengthy and Stream_MainUser decides that this content item will be presented as 3 slides. This creates 3 slide items in the Document View editor that are all linked to the Introduction content item. This link ensures that the Document View editor always presents an accurate and current version of the Introduction content item. By default, this item is linked to the original content item in the Stream view editor. Any changes made to the Introduction text are applied to the original item and reflected in the proposal. However, two sets of additional markup (stored as tags within the content item metadata for the Introduction item) can now be added: slide markup and style markup. Slide markup allows for the user to type an independent summary version of the text or to reformat the line breaks, fonts, colors and other visual style elements of the Introduction text so that it can be displayed across the available slides created for this purpose (in our example, there are 3 slides available to distribute the text across). These formatting elements are inserted as tags superimposed on the existing content item—the additional tags are not stored in-line to the content item text in the Stream data tier; they are inserted into the content item dynamically as part of the compositing and rendering process that generates the visual format of the 3 slides and the Introduction text as Stream_MainUser has formatted in the Document View editor. The original content item is thus, pristine and never corrupted with either tag markup or style markup. Style markup can also be used to present information in bulleted and indented lists using popular visual layouts such as organization charts and information trees.

Stream_MainUser can now generate a document view of the resultant presentation that can be used to present slides to the management team of XYZ. The document view can also be exported into popular formats such as PDF and HTML.

### Assembling and Styling the Main Deliverables

Once the team has contributed all the necessary content to the different sections of the proposal, Stream_MainUser can now create another document view—this one for Reading/Printing as opposed to presenting. This document view will feature the visual formatting and styles (header/footer, cover page, logos, table of contents) that are required to create a professional proposal from the core content items in the Web Site proposal activity. The Document View editor enables the view markup for the headers, footers and additional content such as Title, Authors etc. Style markup layers can apply font styles, color and additional page formatting (page break tags) for printing convenience. The proposal is then exported into PDF or HTML and shared with the Customer Lead for approval.

### Publishing Deliverables to Protect the IP Therein

The Stream cloud features a unique option to publish the contents of an activity, document view or even just an individual content item. Publishing pushes an immutable copy of the content to the Stream cloud for permanent storage and also, makes a unique hash signature of that content available publicly with the globally unique identifier(s) of the content item(s) involved—this is to ensure that the content signature can be verified by anyone and can be used to prove that the particular combination of characters in the content was published by a verified user, company or government entity. In our example, Stream_MainUser chooses to publish the proposal prior to having it signed off by the Customer Lead to ensure that an independently verifiable copy is available from Citta.

### Licensing Content to the Customers (Including Payment)

When content that features some sort of intellectual property needs to be exchanged, Streams offers the ability to license that content between users, companies and government entities. A license may be permanent full-rights or partial rights subject to terms of agreement documented by the content owner. Content models, document views and content items can all be individually licensed between users, with a fee being charged by Citta for transacting and supporting the sale and license. The license can also come with a price tag that can be set by the content owner and payment via standard Internet payment gateways could be required to obtain the license and content. The Stream cloud can be used as a content marketplace where content can be advertised, bought and sold. Prospective content authors and collaborators can also advertise services and fees and prospective content customers can advertise and auction content authoring jobs and projects, including pro bono and social projects. Stream Cloud projects have two automated capabilities—one is a native integration with popular social & professional networking platforms (Facebook, Google+, LinkedIn) and the other is a native HTML base that allows these projects to be advertised, published, shared on the web with minimal to no-knowledge of HTML by Stream users.

### Printing and Export Options

When the Web Site proposal is available to be sent to the Customer Lead, Stream_MainUser decides to add a few additional informational content items in the proposal featuring Customer testimonials, track records and previous clients of the team and other case studies as optional information. When the Customer Lead is notified via email of the readiness of the proposal, a link is supplied that renders the proposal in the Stream cloud in a browser. The rendered document view of the proposal allows the Customer Lead to decide if the optional information should be included while printing or exporting the document view to PDF or sharing it with others within XYZ. The Customer Lead can even choose exactly which pieces of additional information is desirable in the version of the proposal that is to be circulated for review. This allows the deliverable to behave in a dynamic fashion different from traditional documents.

### Information Navigation and Creation in Streams

Streams has an ability to track time and context. Users typically navigate into activities on the basis of time—basic context selection is one click and the user is presented with what items were last updated in a work session in reverse chronological order (latest first). The Stream client also defaults to focusing on the last Content Item that was worked on per activity. Users can setup additional context reminder options such as an overview of the Focus Guide status (what content items have been created, what marked completed, what items have not been started yet, % complete, etc.). These context reminders are necessary since the Stream will always return the user to the last state of the activity—which might be a document view, for example—and hence the user may choose to refresh their minds of what activity has occurred in Stream View before continuing to edit the document. The most important aspect of understanding context, both in resuming a working session as well as in the creation of inter-related content, is a spatial sense of where focus is against the backdrop of the larger content canvas. To provide the user with a powerful spatial tool that aligns with the human way of thinking in three-dimensions, Streams provides an underlying Content Spatial Zoom technology that is applied across different functions to enable users to navigate and visualize content in a rich manner.

### The Content Spatial Zoom platform

Content Spatial Zoom refers to the functional characteristics of the Content Stream Engine to allow the creation of spatial views in applications that allow the user to browse, navigate to & even create content using complex, multi-dimensional and multi-valued relationships between objects in the Stream including users, time, geography and any and all implicit content relationships. Implicit content relationships are those established by the core Stream constructs when Content Items are created & edited, primarily credentials, activities, versions and document views.

Spatial zoom is thus a platform capability that allows for the selection of a subset of content (i.e. the level of zoom) from a Stream along with associated metadata that is then rendered on a content map. The 2-dimensional visual map represents all objects in the scope of the current view and their relationships/associations including parent-child and aggregation relationships. The act of zooming out or zooming in on the map changes the parameters of the selection criteria, resulting in either more objects being rendered or more attributes of an already selected (“zoomed-in”) object. Zooming out can even render content outside the user's stream—that they may have received or contributed during collaboration or work projects—as well as other related objects such as geographic locations and other users. The content map can function in many visualization modes, with layers of additional data that can be turned on/off depending on the needs of the user.

The 4 main layers are: Time, Geography, Content Associations and People. The main visualization modes are Grid mode (where content is rendered in tabular form), Directed Graph mode (which is the native mode of the Stream platform), Tree mode, Earth mode, Timeline mode and Card mode.

### Spatial Zoom Layers

1. Time: Examples of time-based views include—
a. Versions of content items, with the ability to scroll through content changes and compare items to see what changed.
b. Activity expansion over time, which illustrates the addition and modification of content within an activity over time.
c. Document View expansion over time, which illustrates the addition and modification of content within a document view over time (including document view markup objects and style layers).
d. Visual timeline of edit activity across contexts, which illustrates editing/collaboration activity across different activities and contexts over time.

2. Geography
a. Visual aggregation of content items by the automatic values associated with place of creation & place of last edit rendered in a geographic map.
b. Named locations associated with geographic data showing content items assigned to those named locations by the user.

3. Content Associations
a. Implicit associations: include views that show items in an activity, items in a document view, all activities that share a particular content item and all document views that refer to a specific content item.
b. Tabular association of content items: a simple row-column relationship of a set of content items that are all children of a single parent content item, which they describe. Standard data in tables would fall in this category but instead of handling numerical values, Streams handles large complex content items (including binaries such as pictures or video) using this mechanism. Typically rendered using Grid mode. Additional aspects of the view include browsing through versions of each row of associated content items.
c. Model Relationships: Content items are most commonly related through a model. The model may describe the content structure (chapters, sections, related-references) of a single set of content items and this structure is rendered in the spatial view (can be represented in multiple modes). These relationships are typically assigned by the end-user. Model attributes can also be used to describe how to visually render content in different content items at different parts of the model in an intuitive fashion at run-time.

4. People
a. Collaboration and contribution activity across a single activity, a set of activities or across contexts featuring users and the related content items in scope of the view.
b. Timescale of interaction and contribution by user(s) across a single activity or a set of activities or across contexts.
c. Ownership and references to content items owned by users.
   Note: In all places above where users are referenced, Companies or Government Entities may be involved as legal owners of the Stream(s) involved.

### Advantages of Stream Networks

Stream enabled networks have the following advantages:
1. Intellectual Property rights on content. Offered via our strong credential service combined with the Stream Cloud to ensure that a legally valid copy of content is available to prove ownership and time of publication on the Web.
2. Ability to store & manage existing content on a personal computer using Streams locally, at a granular level (not documents or files excluding binary files used for pictures, audio and video) featuring globally uniquely-identified pieces of content known as Content Items.
3. Ability to compose commercial, high-value content including traditional documents (for reading or presentation) by assembling these from Content Items as defined earlier.
4. Ability to collaborate, exchange, version, aggregate, publish, reformat, re-arrange visually, sell Content Items as part of the content management and authoring workflow of a productivity solution. Note: Content Items are not equivalent to Files, Documents in competing productivity suites and Pages within documents in competing productivity suites.
5. Ability to re-use and visually reformat the flow of the same Content Items to create different documents or different versions of the same document, including the creation of side-by-side simultaneous alternative versions of a document or even Content Items within a document.
6. Ability to convert home personal computers and personal storage devices into private and public web applications to allow time-limited free sharing of the most recent content hosted and distributed for a few days via the Citta Stream Cloud, more extensive long-term sharing (and storage quotas) via a paid account with the Citta Stream Cloud, both offerings being accessible as unique Web sites on browsers across devices and platforms and indexed by popular search engines. This effectively allows users to use their personal resources at home in the creation of a web-sharing paradigm for publishing pictures, documents, blogs and a personal web site featuring resume/bio information and advertising skills and services for commercial content creation engagements that can be initiated, managed, tracked and paid for via the Citta Stream Cloud.

### Example of Content Creation within the Stream Environment

With reference to FIG. 8 content is created within a user specific stream. The identity of the user is determined based on the context, location, and profile of the user. Upon login 805 a user profile is selected 807. The user profile can determined based on login criteria, manually selected by the user, or automatically determined based on context of the user location, terminal, recent content accessed or other attributes. A determination for existing activity is made 808. If no activity is found, new activity is created 809. And if activity exists, the existing activity may be selected 810. A content item is created 812 associated with the existing activity. Attributes or tags are assigned to the content item 814. The content item created can represent any content the user creates. Attributes may be assigned to the content item either automatically based on the context of the content or may be manually assigned by the user. One or more content models associated with the content item may be defined 816. A document may be created from the content and content model. The content items/models can be filtered by selecting assigned attributes and tags 818. The Content items/models are arranged in a desired sequence 820 and a document view or style layer is selected 825 and applied to publish a document 830. Once the document is published it can be shared with other users 835. Once the document is shared with other users, the additional document views and style layers can be selected by the new user 840. The new user can publish the document 845 and share with additional users 850.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous

What is claimed is:

1. A method performed by data processing apparatus, the method comprising:
creating a content item;
creating a content model associated with the content item;
assigning one or more attributes or tags the content item or content model;
selecting a content view style for the content item;
publishing the content item or content model in the selected content view style.

2. The method of claim 1 wherein the content item is associated with a unique user identity.

3. The method of claim 1 wherein the content item comprises alphanumeric text, audio data, graphical data, or video data.

4. The method of claim 1 wherein the content model further associates the content item with other content items related by context of the data comprising the content item.

5. The method of claim 1 wherein the one or more attributes or tags are automatically assigned to the content item or content model based on the context of the content item, user identity, time, geographic location; or other tags previously assigned to the content item.

6. The method of claim 1 wherein the one or more attributes or tags comprise a user assigned value; and automatically assigned value; or a collaboratively assigned value.

7. The method of claim 1 wherein the content view style comprises a textual document, a graphical document; a multi-media document; a report, a textual presentation, a slide presentation; a multi-media presentation; an audio presentation; an e-mail, a text message, an MMS message, a social media entry; an Internet instant chat message; a basic numerical computation model; or a PDF document.

8. The method of claim 1 wherein publishing the content item in the selected viewing style comprises displaying the content item in the selected viewing style on computer monitor, on a remote monitor, on a remote display, on a projected display, on a laptop computer display, on a mobile device, on a cellular telephone, on a tablet computer, or playing an audio file over a speaker, broadcasting the content item over a network, web presentation, e-reader view, or printing the content item in the selected viewing style.

9. The method of claim 1 further comprising selecting multiple content view styles for a single content item or content model.

10. The method of claim 1 further comprising:
editing the content item or content model; and
assigning one or more attributes or tags to the edited content item or content model.

11. The method of claim 10 wherein editing the content item or content model is performed by at least to user identities or at least one user identity at different times.

12. The method of claim 1 further comprising:
storing the content item, content model, and one or more attributes or tags in a content stream associated with a user identity.

13. A method performed by data processing apparatus, the method comprising:
receiving a content item via a user input, wherein the content item is associated with a unique user identity;
associating the content item with one or more content models;
assigning one or more attributes or tags to the content item or content model;
receiving a selected content view style and assigning the content view style to the content item;
publishing the content item in the content view style.

14. The method of claim 13 wherein the content item comprises alphanumeric text, audio data, graphical data, or video data.

15. The method of claim 13 wherein the content model further associates the content item with other content items related by context of the data comprising the content item.

16. The method of claim 13 wherein the one or more tags or attributes are automatically assigned to the content item or content model based on the context of the content item, user identity, time, geographic location; or other tags previously assigned to the content item.

17. The method of claim 13 wherein the one or more attributes or tags comprise a user assigned value; and automatically assigned value; or a collaboratively assigned value.

18. The method of claim 13 wherein the content view style comprises a textual document, a graphical document; a multi-media document; a report, a textual presentation, a slide presentation; a multi-media presentation; an audio presentation; an e-mail, a text message, an MMS message, a social media entry; an Internet instant chat message; a basic numerical computation model; or a PDF document.

19. The method of claim 13 wherein publishing the content item or content model in the selected viewing style comprises displaying the content item in the selected viewing style on computer monitor, on a remote monitor, on a remote display, on a projected display, on a laptop computer display, on a mobile device, on a cellular telephone, on a tablet computer, or playing an audio file over a speaker, broadcasting the content item over a network, or printing the content item in the selected viewing style.

20. The method of claim 13 further comprising selecting multiple content view styles for a single content item.

21. The method of claim 13 further comprising:
editing the content item or content model; and
assigning one or more attributes or tags to the edited content item or content model.

22. The method of claim 21 wherein editing the content item or content model is performed by at least to user identities or at least one user identity at different times.

23. The method of claim 13 further comprising:
storing the content item, content model, and one or more attributes or tags in a content stream associated with a user identity.

24. A computer storage medium encoded with a computer program, the program comprising instructions that when executed by data processing apparatus cause the data processing apparatus to perform operations comprising:
receiving a content item, wherein the content item is associated with a unique user identity;
associating the content item with one or more content models;
assigning one or more attributes or tags to the content item or content model;
receiving a selected content view style and assigning the content view style to the content item;
publishing the content item in the content view style.

25. The computer storage medium encoded with a computer program of claim 24 further comprising:
editing the content item or content model; and
assigning one or more attributes or tags to the edited content item or content model.

26. The computer storage medium encoded with a computer program of claim 25 wherein editing the content item or content model is performed by at least to user identities or at least one user identity at different times.

27. The computer storage medium encoded with a computer program of claim 24 further comprising:
storing the content item, content model, and one or more attributes or tags in a content stream associated with a user identity.

28. A system comprising:
a user device; and
one or more computers operable to interact with the device and to:
receive a content item, wherein the content item is associated with a unique user identity;
associate the content item with one or more content models;
assign one or more attributes or tags to the content item or content model;
receive a selected content view style and assign the content view style to the content item; and
publishing the content item in the content view style.

29. The system of claim 28, wherein the one or more computers comprise a server operable to interact with the device through a data communication network, and the device is operable to interact with the server as a client.

30. The system of claim 28, wherein the device comprises a personal computer running a web browser, or a mobile device running a browser.

31. The system of claim 28, wherein the one or more computers consist of one computer, the device is a user interface device, and the one computer comprises the user interface device.
